(19) United States
(12) Patent Application Publication
(10) Pub. No.: US 2012/0328892 A1
(43) Pub. Date: Dec. 27, 2012

(54) NON-BLOOMING LOW FORMALDEHYDE COATING COMPOSITION

(75) Inventor: Shaobing Wu, Jamestown, NC (US)

(73) Assignee: VALSPAR SOURCING, INC., Minneapolis, MN (US)

(21) Appl. No.: 13/582,615

(22) PCT Filed: Mar. 8, 2011
(86) PCT No.: PCT/US2011/027592

§ 371 Date: Sep. 4, 2012

Related U.S. Application Data
(60) Provisional application No. 61/312,091, filed on Mar. 9, 2010.

(51) Int. Cl. C09D 167/02; B32B 27/42; B05D 7/24

(52) U.S. Cl. 428/524; 524/539; 524/605; 427/385.5

(57) ABSTRACT

Blooming may be reduced or eliminated in a low formaldehyde amino resin-crosslinkable coating composition by including in the composition, in addition to the ingredients necessary to form a crosslinked coating, an anti-blooming agent containing one or more of (i) an acid-functional polymer, (ii) ethylene glycol, propylene glycol or an ethylene glycol or propylene glycol polymer or copolymer, or (iii) for compositions containing the acidic catalyst p-toluene sulfonic acid (PTSA), a further acidic cure catalyst having greater hydrophobicity than PTSA. The anti-blooming agent has particular value in amino resin-crosslinkable alkyd resin formulations, but may be used in amino resin-crosslinkable coating compositions based on other film-forming polymers bearing amino resin-reactive functional groups including appropriately functionalized acrylic, polyester, vinyl and cellulose acetate butyrate (CAB) resins and nitrocellulose lacquers.

### FIELD

This invention relates to coatings for wood and other substrates.

### BACKGROUND

Solvent-borne alkyd coating compositions are widely used in wood coating applications, for example to coat kitchen cabinetry and other wooden furnishings. These coating compositions are mainly based on formulations catalyzed with acids and crosslinked with amino resins. Owing to concerns regarding formaldehyde emissions, efforts have been made in recent years to replace traditional amino resin crosslinkers with crosslinkers that do not release formaldehyde during or after cure. In some instances this has been done using crosslinkers based on substituted secondary amines that cure without liberating formaldehyde.

### SUMMARY OF THE INVENTION

Tests carried out by the applicant have shown that some substantially formaldehyde-free or low formaldehyde amino resin-crosslinked coating compositions exhibit a tendency to undergo “blooming”, that is, the formation of a visible deposit, discoloration or objectionable haziness on or within a cured coating. Blooming is different from separation, settling or other evidence of poor stability in an uncured coating composition, and may occur even when the coating composition ingredients do not exhibit apparent stability problems prior to cure.

Blooming may be reduced or eliminated in a low formaldehyde amino resin-crosslinkable coating composition by including in the composition, in addition to the ingredients necessary to form a crosslinked coating, an anti-blooming agent comprising one or more of (i) an acid-functional polymer, (ii) ethylene glycol, propylene glycol or an ethylene glycol or propylene glycol polymer or copolymer, or (iii) for compositions containing the acidic catalyst p-toluene sulfonic acid (PTSA), a further acidic cure catalyst having greater hydrophobicity than PTSA. The disclosed anti-blooming agent has particular value in amino resin-crosslinkable alkyd-containing resin formulations, but may be used in amino resin-crosslinkable coating compositions based on or containing other film-forming polymers having amino resin-reactive functional groups (e.g., hydroxyl groups), such as appropriately functionalized acrylic, polyester, vinyl and cellulose acetate butyrate (CAB) resins and nitrocellulose lacquers.

The present invention thus provides, in one aspect, a liquid coating composition comprising sufficient amounts of:

(a) crosslinkable film-forming polymer,

(b) acidic cure catalyst,

(c) low formaldehyde amino resin crosslinker, and

(d) anti-blooming agent comprising one or more of:
(i) acid-functional polymer,
(ii) ethylene glycol, propylene glycol or an ethylene glycol or propylene glycol polymer or copolymer, or
(iii) for compositions containing the acidic catalyst PTSA, further acidic cure catalyst having greater hydrophobicity than PTSA
   to provide a substantially non-blooming crosslinked coating when a continuous film of such composition is applied to a suitable substrate.

The invention provides, in another aspect, a coated article (e.g., a coated wood article) comprising a substrate having thereon a layer of a liquid coating composition comprising a homogenous mixture containing sufficient amounts of:

(a) crosslinkable film-forming polymer,

(b) acidic cure catalyst,

(c) low formaldehyde amino resin crosslinker, and

(d) anti-blooming agent comprising one or more of:
(i) acid-functional polymer,
(ii) ethylene glycol, propylene glycol or an ethylene glycol or propylene glycol polymer or copolymer, or
(iii) for compositions containing the acidic catalyst PTSA, further acidic cure catalyst having greater hydrophobicity than PTSA
   to provide a substantially non-blooming crosslinked coating when such layer is crosslinked or otherwise hardened.

The invention provides, in yet another aspect, a method for coating an article, which method comprises applying to a suitable substrate a liquid coating composition comprising a homogeneous mixture of:

(a) crosslinkable film-forming polymer,

(b) acidic cure catalyst,

(c) low formaldehyde amino resin crosslinker, and

(d) anti-blooming agent comprising one or more of
(i) acid-functional polymer,
(ii) ethylene glycol, propylene glycol or an ethylene glycol or propylene glycol polymer or copolymer, or
(iii) for compositions containing the acidic catalyst PTSA, further acidic cure catalyst having greater hydrophobicity than PTSA
   and crosslinking the coating composition to provide a hardened continuous substantially non-blooming film.

### DETAILED DESCRIPTION

Unless the context indicates otherwise the following terms shall have the following meaning and shall be applicable to the singular and plural:

The terms “a,” “an,” “the,” “at least one,” and “one or more” are used interchangeably. Thus, for example, a coating composition that contains “an” additive means that the coating composition may include “one or more” additives.

Terms denoting orientation such as “atop”, “on”, “uppermost” and the like as used to describe the location of various elements in a coated or coatable article refer to the relative position of the element with respect to a horizontal support or reference plane, and are not intended to imply that such elements or article should have any particular orientation in space during or after their manufacture.

The term “acid number” means the milligrams of potassium hydroxide required to neutralize one gram of polymer solids, and may be evaluated according to ASTM D 974-04.

The term “acid-functional polymer” means a polymer having an acid number of at least about 2 and more preferably at least about 5.

The term “blooming” refers to the formation of a visible deposit, discoloration or objectionable haziness on or within a cured coating that has been cured, crosslinked, polymerized or otherwise hardened.

The term “coating thickness” refers unless otherwise specified to the thickness of a wet coating before it has been hardened.

The term “copolymer” includes alternating, random and block copolymers.

The term “esterified polymerization product” means a polymerization product of monomers that are capable of being synthesized from esterification or transesterification reactions of one or more polyols and one or more aliphatic or aromatic polycarboxylic acids.

The term “film-forming” when used with respect to a polymer refers to a material that can be coated, as is or in a suitable solvent or other vehicle, in a thin layer (e.g., of about 0.05 mm wet thickness) on a suitable support and hardened to form a substantially continuous coating that may be generally characterized as solvent insoluble, but which may be swellable in the presence of an appropriate solvent.

The term “homogenous” when used with respect to a composition or mixture refers to a liquid that on visual inspection appears to have a single phase free of precipitates or undissolved solids. A homogenous composition or mixture may be found on more detailed inspection to be a suspension, dispersion, emulsion or other microscopically multiphase form.

The term “hydroxyl number” means the milligrams of potassium hydroxide required to neutralize one gram of polymer solids whose hydroxyl groups have been acetylated using acetic anhydride, and may be evaluated according to ASTM D 1957-86 (Reapproved 2001).

The term “low formaldehyde” when used with respect to an amino resin-crosslinked coating refers to a coating that can be cured with little (e.g., less than about 0.1 weight percent of the crosslinker amount) or no formaldehyde release.

The term “overcoated” when used to describe the position of a layer with respect to a support or other element (e.g., an underlying layer) in a coated article refers to the recited layer as being atop the support or other element, but not necessarily contiguous to the support or other element.

The term “polymer” refers to homopolymers and copolymers (including oligomers) having three or more repeating units, as well as to homopolymers or copolymers that may be formed in a miscible blend, e.g., by coextrusion or by reaction, including, e.g., transesterification.

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

The term “separated by” when used to describe the position of a first element with respect to two other elements refers to the first element as being between the other elements but not necessarily contiguous to either other element.

The term “solids content” refers to the percent by weight of non-volatile components in a composition, and may be evaluated according to ASTM D 1259-85. For example, an alkyd resin with an 80 percent solids content will contain 80 weight percent non-volatile components and 20 weight percent volatile components.

The term “solvent” includes nonaqueous organic solvents and water.

When used with respect to a component which may be found in a mixture, the term “substantially free of” means containing less than about 5 weight percent of the component based on the mixture weight.

The term “undercoated” when used to describe the position of a layer with respect to a layer or other element (e.g., an overlying layer) in a coated article refers to the recited layer as being between an underlying support and the overlying layer or other element, but not necessarily contiguous to the support, overlying layer or other element.

The recitation of a numerical range using endpoints includes all numbers subsumed within that range (e.g., 1 to 5 includes 1, 1.5, 2, 2.75, 3, 3.80, 4, 5, etc.).

The disclosed anti-blooming agent may be an acid-functional polymer. A variety of acid-functional polymers may be used, including carboxyl-functional acrylics, carboxyl-functional acrylic polyols and carboxyl-functional alkyds. The acid-functional polymer may for example have an acid number of about 2 to about 200, about 5 to about 100 or about 8 to about 50. The acid-functional polymer may be a film-forming or a non-film-forming polymer, may be solvent-soluble (and if desired, water-soluble), may be volatile or non-volatile after cure, and may be reactive or non-reactive with the above-mentioned crosslinkable film-forming polymer or the above-mentioned amino resin crosslinker The acid-functional polymer may have other functional groups (e.g., hydroxyl groups) and may if desired have its acid groups converted to salt groups by reaction with a suitable base. Exemplary commercially available acid-functional polymers include JONCRYL™ 67, JONCRYL 586 and JONCRYL 611 styrene acrylic resins (all from BASF Performance Chemicals), and PARALOID™ AU 608 S carboxyl-functional acrylic polyol from Dow Chemical Company. The acid-functional polymer desirably is sufficiently soluble or dispersible in the disclosed coating compositions so that a homogenous mixture will be formed when the acid-functional polymer is combined with the other ingredients in the coating composition. The acid-functional polymer may if desired be dissolved or dispersed in a suitable solvent or mixture of solvents before being combined with such other ingredients, e.g., to assist in mixing or to provide or maintain a homogenous coating composition. The amount of acid-functional polymer in the disclosed coating compositions may depend on the polymer acid number, in that lower amounts of high acid number polymers may provide anti-blooming effects comparable to those obtained using higher amounts of low acid number polymers. Thus the amount of acid-functional polymer may for example be about 0.1 to about 50 percent, about 0.5 to about 40 percent or about 1 to about 40 percent of the total coating composition weight based on polymer solids.

The disclosed anti-blooming agent may be ethylene glycol, propylene glycol or an ethylene glycol or propylene glycol polymer or copolymer (sometimes collectively referred to below as the “glycol agent”). A variety of glycol agents may be used, having for example a number average molecular weight of 62 to about 50,000 or 62 to about 25,000. Exemplary commercially available glycol agents include VORANOL™ 220-530 and VORANOL 220-056N diol polyether polyols and VORANOL 232-034 and VORANOL 5815 triol polyether polymers (all from Dow Chemical Company). The glycol agent desirably is sufficiently soluble or dispersible in the disclosed coating compositions so that a homogenous mixture will be formed when the glycol agent is combined with the other ingredients in the coating composition. The glycol agent may if desired be dissolved or dispersed in a suitable solvent or mixture of solvents before being combined with such other ingredients, e.g., to assist in mixing or to provide or maintain a homogenous coating composition. The amount of ethylene glycol or propylene glycol content contributed by the glycol agent may for example be about 0.3 to about 50 percent, about 0.5 to about 30 percent or about 1 to about 20 percent of the total coating composition weight.

For compositions containing the acidic catalyst PTSA, the disclosed anti-blooming agent may be a further acidic cure catalyst having greater hydrophobicity than

PTSA. Hydrophobicity may be evaluated based on water solubility or based on structural considerations such as the size and arrangement of alkyl or other groups or other substituents in the further acidic cure catalyst. A variety of further acidic cure catalysts may be used, including dinonylnaphthalene sulfonic acid, dinonylnaphthalene disulfonic acid, dodecyl benzene sulfonic acid and the like. Exemplary commercially available further acidic cure catalysts include CYCAT™ 500 dinonylnaphthalene disulfonic acid and CYCAT 600 dodecyl benzene sulfonic acid (both from Cytec Industries, Inc.) and NACURE™ 166, NACURE 3056, NACURE 4054 and NACURE 5076 acid catalysts from King Industries. The further acidic cure catalyst desirably is sufficiently soluble or dispersible in the disclosed coating compositions so that a homogenous mixture will be formed when the further acidic cure catalyst is combined with the other ingredients in the coating composition. The further acidic cure catalyst may if desired be dissolved or dispersed in a suitable solvent or mixture of solvents before being combined with such other ingredients, e.g., to assist in mixing or to provide or maintain a homogenous coating composition. The amount of further acidic cure catalyst in the disclosed coating compositions may for example be about 1 to about 99, about 5 to about 90 or about 10 to about 80 percent of the total catalyst amount, and the total catalyst amount may for example be about 0.1 to about 20, about 0.2 to about 10 or about 0.5 to about 6 percent of the total coating composition weight.

As noted above, alkyd resins are an exemplary crosslinkable film-forming polymer. They may be prepared using a variety of techniques, including those described in U.S. Pat. Nos. 4,133,786, 4,517,322, and 6,946,509 B2 in U.S. Patent Application Publication No. US 2008/0275192 A1, and in International Application No. PCT/US2009/068807 filed 18 Dec. 2009. The alkyd resin desirably is the reaction product of a polyester component and a fatty acid component, and the polyester component desirably is the reaction product of an acid component and a polyol component. The various alkyd resin reactants may be added to a reaction vessel at the same time or added sequentially in any suitable order or grouping. One or more time delays may be included between reactant additions. The product alkyd resin may be hydroxyl-functional, acid-functional or both hydroxyl- and acid-functional, and may have other functional groups including sites of unsaturation to provide air-drying characteristics. The alkyd resin may for example have an acid number of about 2 to about 30, about 5 to about 25 or about 5 to about 15, and may if desired be non-acid-functional.

Exemplary acid components include aromatic or aliphatic polycarboxylic acids, their anhydrides, and esterified polymerization products of one more polyols and one or more of such polycarboxylic acids or their anhydrides. The acid component may for example be difunctional (e.g., phthalic acid), or trifunctional (e.g., trimellitic acid), with difunctional acids and their anhydrides being preferred. Non-limiting examples of difunctional acids include ortho-phthalic acid, isophthalic acid, terephthalic acid, tetrahydrophthalic acid, succinic acid, adipic acid, naphthalene dicarboxylic acid, anhydrides of these (e.g., phthalic anhydride), mixtures thereof and the like. The acid may be unsaturated (e.g., maleic acid, fumaric acid, itaconic acid or a dimerized fatty acid) or saturated (e.g., succinic acid). The reaction mixture may if desired contain minor amounts of monocarboxylic acids or esters or minor amounts of tetra- or higher carboxylic acids, esters or their anhydrides, including but not limited to ethylhexanoic acid, propionic acid, benzoic acid, 4-methylbenzoic acid, 1,2,4,5-benzenetetracarboxylic acid. Exemplary esterified polymerization products include polyethylene terephthalates. The esterified polymerization products may also be post-consumer materials.

Exemplary polyol components include difunctional alcohols, trifunctional alcohols (e.g., glycerin, trimethylol propane, trimethylol ethane, trimethylol butane, tris hydroxyethyl isocyanurate, etc.), tetrahydric or higher alcohols (e.g., pentaerythritol, diglycerol, etc.), and combinations thereof. Trifunctional alcohols are preferred due to the degree of branching they promote at relatively low monomer cost, and branching is desired to build molecular weight and discourage excessive soak-in. Difunctional alcohols (or diols), if used, are preferably used in combination with trifunctional or higher alcohols. Exemplary diols include neopentyl glycol (NPG), ethylene glycol, propylene glycol, diethylene glycol, triethylene glycol, tetraethylene glycol, pentaethylene glycol, hexaethylene glycol, heptaethylene glycol, octaethylene glycol, nonaethylene glycol, decaethylene glycol, 1,3-propanediol, 2,4-dimethyl-2-ethyl-hexane-1,3-diol, 2,2-dimethyl-1,2-propanediol, 2-ethyl-2-butyl-1,3-propanediol, 2-ethyl-2-isobutyl-1,3-propanediol, 1,3-butanediol, 1,4-butanediol, 1,5-pentanediol, 1,6-hexanediol, 2,2,4-tetramethyl-1,6-hexanediol, thiodiethanol, 1,2-cyclohexanedimethanol, 1,3-cyclohexane-dimethanol, 1,4-cyclohexanedimethanol, 2,2,4-trimethyl-1,3-pentanediol, 2,2,4-tetramethyl-1,3-cyclobutanediol, p-xylenediol, hydroxypivalylhydroxypivalate, 1,10-decanediol, hydrogenated bisphenol A and mixtures thereof. Exemplary trifunctional alcohols (or triols) include glycerin, trimethylolpropane, trimethylolethane, trimethylolbutane, pentaerythritol and dipentaerythritol and mixtures thereof. Glycerin and pentaerythritol are preferred triols.

The acid and polyol components may be combined in a variety of ratios which may vary according to the intended use. If hydroxyl-functional, the product polyester resin may for example have a hydroxyl number from about 10 to about 200, about 30 to about 150 or about 50 to about 150. If acid-functional, the product polyester resin may for example have an acid number from about 2 to about 200, about 5 to about 100 or about 8 to about 50. When used on wood substrates, the product polyester preferably has a hydroxyl number of about 50 to about 150, about 70 to about 150 or about 80 to about 140. The number average molecular weight (Mn) of the product polyester resin may vary according to the intended use and may for example range between about 1,000 and about 20,000, between about 1,500 and about 10,000, or between about 2,500 and about 5,000.

An alkyd resin may be formed by reacting the polyester with a variety of fatty acids in a polycondensation reaction that promotes polymerization and chain growth of the alkyd resin. While not intending to be bound by theory, appropriate selection and use of a fatty acid component may affect the alkyd resin color or the extent to which the coating composition may undergo “yellowing” after cure. For unpigmented coatings, the alkyd resin preferably has a Gardner coloration of 3 or less and more preferably less than 3, as measured using the procedure described in ASTM D 1544-04. Alkyd resins with greater

Gardner coloration may be used where resin color or yellowing are not a concern (e.g., in appropriately pigmented compositions), or may find use in moderation where some resin coloration or yellowing is acceptable. If the alkyd resin is made from one or more fatty acid components, they preferably include one or more substantially saturated naturally occurring fatty acids. Preferably, the fatty acid contains up to 18, and more preferably between about 6 and 16 carbon atoms. Exemplary substantially saturated fatty acids include palmitic acid, lauric acid, stearic acid, capric, caprylic acid, myristic acid, arachidic acid, behenic acid, lignoceric acid, and the like. Unsaturated fatty acids, including polyunsaturated fatty acids and partially but not fully hydrogenated unsaturated fatty acids, may also be employed. Exemplary unsaturated fatty acids include linolenic acid (C18:3); linoleic acid (C-18:2); and oleic acid (C-18:1). Naturally occurring fatty acids may also be employed, including those which are largely saturated (e.g., coconut oil and palm kernel oil) and those with appreciable unsaturation (e.g., castor oil, tall oil fatty acid, linseed oil, soybean oil, palm oil, and safflower oils). Coconut oil is a preferred and economical fatty acid and can be used to make alkyd resins with low Gardner coloration. The fatty acid component may for example represent between about 20 and about 40 weight percent, between about 25 and about 40 weight percent, or between about 30 and about 35 weight percent of the alkyd resin.

Polycondensation preferably is carried out at a temperature of at least about 150° C., and more preferably at a temperature of at least about 200° C. In some embodiments, polycondensation is carried out at a temperature of less than about 280° C., of less than about 250° C. Water produced during formation of the alkyd resin may be removed using any methods known in the art, including the use of distillation columns, distilling under reduced pressures, azeotropic distillation using a suitable organic solvent (e.g., xylene), or combinations thereof. In embodiments employing an esterified polymerization product (e.g., a polyethylene terephthalate), the polymerization reaction desirably generates substantially no water as a condensate by-product. This is beneficial for providing high yields of reaction, while reducing the waste stream.

An alkyl resin formation catalyst (e.g., lithium) may be included in the reaction mixture to assist in alkyd resin production. A gas (e.g., an inert gas) may optionally be passed through the reaction mixture. In some situations, undesirable side reactions may occur if steps are not taken to minimize or eliminate their occurrence. These undesirable side reactions may adversely affect the properties of the alkyd resin (e.g., color, molecular weight, acid number, hydroxyl number, viscosity, etc.), reduce the total alkyd resin yield, or result in the production of undesirable substances. Preferably, care is taken during the resin synthesis to avoid overshooting the desired end point, e.g., attainment of a desired hydroxyl number. When forming high molecular weight alkyd resins using typical interval sampling techniques and viscometric measuring to monitor the reaction progress, it may be all too easy to overshoot the desired reaction endpoint. Alternative monitoring methods such as the use of an inline continuous viscometer or a non-viscometric monitoring technique may make it easier to halt the reaction near a desired endpoint. Exemplary non-viscometric monitoring techniques include monitoring stirrer torque, using near-IR analysis to measure the disappearance of hydroxyl and acid groups, and using nuclear magnetic resonance as described in U.S. Pat. No. 6,887,953 B2. The measurement results may also be used to determine whether additional starting material (e.g., additional acid, glycol or fatty acid) should be added to the reactor to correct the reaction mixture and assist in reaching a targeted alkyd resin product. Non-viscometric techniques may also be combined with one another or with viscometric techniques to provide improved reaction monitoring.

For wood coatings, the alkyd resin preferably has a molecular weight and viscosity sufficient to permit rapid flow and leveling to form a smooth, continuous glossy coating on porous wood (including end grain wood) without excessive strikethrough or even without any strikethrough. The desired molecular weight and viscosity for coating wood end grain may be greater than the values customarily found in alkyd resins used for coating wood face grain. This may be compensated for by also using a higher than normal solvent amount or lower than normal solids level in the coating composition. The alkyd resin number average molecular weight for such wood coating applications preferably is at least about 2,000, and may for example be between about 2,000 and about 7,000, between about 2,500 and about 6,000, or between about 2,500 and about 5,000 as evaluated using gel permeation chromatography and a polystyrene standard. The alkyd resin kinematic viscosity for such wood coating applications preferably is less than about 95 cm²/second or Stokes, as measured using a 70 weight percent solution of the alkyd resin in a 28:2 by weight butyl acetate:xylene mixture, a 25° C. sample temperature and the procedure described in ASTM D 1545-07. The results may be reported in bubble seconds or approximate Stokes, or alternatively may be determined using Gardner-Holdt tubes, and may be converted to Stokes using the tabular comparisons provided in ASTM D-1545-07. The kinematic viscosity of the alkyd resin solution may for example be less than about 95 Stokes (less than Gardner-Holdt Z5) or less than about 70 Stokes (less than Gardner-Holdt Z4), and may for example be greater than about 37 Stokes (greater than Gardner-Holdt Z2) or greater than about 45 Stokes (greater than Gardner-Holdt Z3).

For wood coatings, the alkyd resin component preferably is employed in the disclosed coating compositions in an amount sufficient to evenly coat wood end grain in two coats (or better yet one coat) without strikethrough. For example, the disclosed coating compositions may include at least about 20, at least about 30 or at least about 40 weight percent alkyd resin component, based on the total coating composition weight including solvents. Exemplary amount ranges for the alkyd resin component are between about 10 and about 90, between about 20 and about 80, between about 30 and about 70, or between about 40 and about 60 weight percent of the total coating composition weight.

The disclosed coating compositions may be made from other film-forming polymers bearing amino resin-reactive functional groups. Exemplary such polymers include appropriately functionalized acrylic, polyester, vinyl and cellulose acetate butyrate (CAB) resins and nitrocellulose lacquers. Mixtures of film-forming polymers may also be employed, for example mixtures of alkyd resins and acrylic resins.

The disclosed coating compositions contain an acidic cure catalyst. Exemplary acidic cure catalysts may be inorganic or organic, and include mineral acids, sulfonic acids such as paratoluene sulfonic acid, dinonylnaphthalene sulfonic acid, dinonylnaphthalene disulfonic acid, dodecylbenzene sulfonic acid and the like, aliphatic acids such as oxalic acid, maleic acid, phthalic acid, acrylic acid and the like, and phosphorus acids such as ethyl acid phosphate, phosphoric acid, dimethyl acid pyrophosphate and the like.

The disclosed coating compositions contain a low formaldehyde amino resin crosslinker. Exemplary amino resin crosslinkers may include those described in U.S. Pat. No. 4,284,758 (North), U.S. Pat. No. 6,207,791 B1 (Bright et al.), U.S. Pat. No. 7,034,086 B2 (Lin et al.), U.S. Pat. No. 7,381,347 B2 (Jacobs, III et al.) and U.S. Pat. No. 7,442,325 B2 (Lin et al.), and in International Application No. WO 2009/073836 A1 (Cytec Technology Corp.), the disclosures of each of which are incorporated herein by reference, and in Jacobs and Courter, Formulating Industrial Wood Coatings with a Novel Formaldehyde-Free Crosslinker to Replace Conventional Aminoplast Crosslinkers”, The Waterborne Symposium, Advances in Intelligent Coatings Design (Feb. 14-16, 2007). The crosslinker may be free of or substantially free of lower alkyl ether linkages (e.g., methyl ether, butyl ether or isobutyl ether linkages). The chosen crosslinker and amount employed may affect factors such as coating hardness, abrasion resistance, and coating flexibility. The crosslinker may for example be present in amounts of less than about 60 weight percent, less than about 50 weight percent or less than about 40 weight percent of the coating composition. Depending upon the film-forming polymer molecular weight and the chosen crosslinker, recommended lower limits for the crosslinker amount are at least about 1, at least about 2, at least about 3, at least about 4 or at least about 5 weight percent of the coating composition. If desired, small amounts of a formaldehyde-releasing crosslinker such as a methylated melamine, urea, benzoguanamine or glycoluril resin may be employed together with the low formaldehyde amino resin crosslinker. A variety of such formaldehyde-releasing crosslinkers are available from Cytec Industries, Inc. under the CYMEL™ name, including CYMEL 303, U 1051 and 1156 crosslinkers.

The disclosed coating compositions may and typically will include one or more solvents. A solvent may function as a carrier for the other components of the coating composition or facilitate the blending of ingredients into a composition suitable for coating or processing, etc. Exemplary solvents include aliphatic and aromatic solvents such as mineral spirits, xylene, alcohols, ketones, esters, glycol ethers, and the like. The solvent may also be water, e.g., to provide a waterborne composition. Mixtures of solvents may be employed, for example, aromatic distillates may be combined with glycol ethers or alcohols. The coating composition may for example contain about 1 to about 50, about 5 to about 40 or about 5 to about 20 weight percent nonaqueous solvent based on the total composition weight. For waterborne compositions, the coating composition may for example contain about 5 to about 90, about 10 to about 70 or about 20 to about 50 weight percent water based on the total composition weight.

An optional reactive diluent or resin may be included in the coating composition. The reactive diluent or resin may be incorporated in the coating composition to facilitate blending of the components of the coating composition, to increase the solids content at application without increasing the coating viscosity or VOC content, or to enhance (in some cases, synergistically) various coating performance characteristics such as adhesion, hardness and chemical resistance. Suitable reactive diluents or resins include vinyl resins, acrylic resins, epoxy resins, oligomers, polyether polyols, and a variety of low molecular weight polyfunctional resins. The optional reactive diluent or resin may for example represent less than about 20 weight percent, between about 1 and about 15 weight percent, between about 1 and about 10 weight percent, or between about 1 and about 5 weight percent of the coating composition.

The disclosed coating compositions may optionally include one or more waxes. A wax may provide lubricity to the composition or abrasion resistance to a finished coated substrate. Exemplary waxes include natural and synthetic waxes such as carnauba wax, petrolatum wax, polyethylene waxes, polymeric waxes, LANOCERIN™ lanolin wax (from Lubrizol Corporation), and the like. The wax may for example represent less than about 2 weight percent, between about 0.5 and about 1.8 weight percent, between about 0.7 and about 1.4 weight percent, or between about 0.9 and about 1.1 weight percent of the coating composition.

The disclosed coating compositions may include one or more flow control agents. Flow control agents may facilitate coating the composition onto a substrate. Exemplary flow control agents include silicones, fluorocarbons, acrylic resins, and the like. A flow control agent may for example represent between about 0.1 and about 3 weight percent, between about 0.4 and about 2 weight percent, or between about 0.5 and 1.5 weight percent of the coating composition.

The disclosed coating compositions may be clear or pigmented as desired. A pigment may for example represent between about 0.1 and about 40 weight percent or between about 1 and about 20 weight percent of the coating composition.

The disclosed coating compositions may if desired include other adjuvants including dyes, fillers, thickeners, dispersing aids, viscosity modifiers, UV absorbers, inhibitors and binders. The amounts and types of such adjuvants will be familiar to or may readily be selected by persons having ordinary skill in the art.

The disclosed coating compositions may be applied to a variety of surfaces, including plastic, metal, masonry and wood surfaces (including veneered wood surfaces and engineered wood). Exemplary woods include hardwood species such as ash, alder, birch, cherry, mahogany, maple, oak, poplar, teak, hickory and walnut, and softwood species such as cedar, fir, pine and redwood. Finished wood products coated with such compositions can have a wide variety of end uses including furniture, kitchen cabinetry, flooring (including engineered flooring) and doors and trim. Other substrates coated with such compositions can have a variety of end uses including building products, transportation products and decorative products. The finishing system components can be applied using a variety of methods that will be familiar to those skilled in the art, including spraying, brushing, roller coating and flood coating. Spraying and roller coating are preferred application methods. The target surface may be cleaned and prepared for application of the disclosed coating system using methods (e.g., a solvent wipe or sanding) that will be familiar to those skilled in the art. The coating composition may be applied in one or more layers, with each layer preferably being applied in an amount sufficient to provide good wet coat coverage and a continuous crosslinked coating. Sufficient coats preferably are applied at coating weights sufficient to provide an uppermost coating layer which is continuously glossy before and after drying and exhibits no runs (and on porous surfaces, no strikethrough). On porous wood end grain, this preferably can be accomplished using three or fewer coats and more preferably using two coats or even one coat, at recommended wet coating thicknesses of about 0.05 to about 0.08 mm. The applied layers should be exposed to sufficient drying conditions (e.g., sufficient heat or air) to obtain thorough crosslinking or cure. These conditions may be determined empirically based on the particular equipment and substrate employed, and the surrounding atmosphere, throughput rate and ambient or elevated temperature at the application site. For wood coatings, a sanding step and a de-nibbing step may be employed for appearance improvement after any or all layers of the disclosed coating composition have been applied and cured, and the coating composition may be undercoated or overcoated with one or more additional layers of sealer, stain, primer or topcoat.

### Bloom, Clarity and Rub Resistance Evaluations

Coating compositions were evaluated by adding a PTSA acidic cure catalyst, low-formaldehyde amino resin crosslinker and varying amounts of several anti-blooming agents to a composition containing a film-forming polymer and solvent, and mixing the ingredients until homogeneous. Single coats of the resulting coating compositions were applied to LENETA™ test charts (from the Leneta Company) at a 0.076 mm wet coating thickness, air flashed for 10 minutes at room temperature, cured at 55° C. for 10 minutes and aged overnight. The crosslinked cured coatings were subjectively evaluated to assess blooming and clarity, using the following zero to five scale:

| Cured Coating Appearance | Rating |
|---|---|
| No evidence of blooming or haziness; | 0 |
| clear | |
| Slightly hazy | 1 |
| Significantly hazy | 2 |
| Moderate blooming | 3 |
| Significant blooming | 4 |
| Severe blooming | 5 |

It should be noted that a coating need not have a zero rating to be regarded as substantially non-blooming or to be acceptable for all end use applications. Coatings with a one rating will be acceptable for many end use applications, and coatings with a two rating may be acceptable for some end use applications. Some of the crosslinked coatings were also evaluated according to ASTM D 5402-93 to determine how many double rubs were required to remove the coating using a cloth soaked in methyl ethyl ketone (MEK).

The invention is further described in the following Examples, in which all parts and percentages are by weight unless otherwise indicated.

### EXAMPLE 1

### Alkyd Resin Preparation

The ingredients shown below in Table 1 were charged to a mixing vessel equipped with an agitator, distillation column, condenser, thermometer, and inert gas inlet. In order to reduce the extent to which side reactions occurred, a reduced batch temperature was employed. The Gardner-Holdt viscosity for a 70 weight percent solution of the alkyd resin and the acid number for the neat resin were measured to assess the reaction progress and arrive at a desired final number average molecular weight. The Gardner-Holdt viscosity measurements used the solvent mixtures shown below in Table 1.

TABLE 1

| | Parts |
|---|---|
| Ingredient | |
| Coconut Oil | 32.63 |
| Maleic Acid | 0.63 |
| Phthalic Anhydride | 40.73 |
| Pentaerythritol | 17.57 |
| Ethylene glycol | 8.44 |
| Reaction Temperature | 220° C. |
| Alkyd Resin Properties | |
| Mₙ | 3,245 |
| 70 wt. % Solution Density (Solvents) | 1.07 g/cm³ (28:2 Butyl |
| | Acetate:Xylene) |
| Gardner-Holdt Viscosity (Resin Solution) | Z4-Z5 |
| Hydroxyl Number | 131 |
| Acid Number | 4.2 |
| Gardner Coloration | 1-2 |
| % Non-Volatiles, 1 gm heated | 70.40 |
| for 1 hour @ 150° C. | |
| Appearance | Clear |

### EXAMPLES 2 AND 3

### Catalyst-Free Coating Compositions

Two coating compositions respectively identified as F1 and F2 made without any acidic cure catalyst were prepared using the Table 1 alkyd resin, an experimental low formaldehyde amino resin crosslinker from Cytec Industries, Inc. believed to be prepared as described in Example 1 of International Application No. WO 2009/073836 A1 and the other ingredients shown below in Table 2:

TABLE 2

| Ingredient | F1 | F2 |
|---|---|---|
| Table 1 Alkyd | 34.29 | 19.7 |
| JONCRYL 587 Styrene-Acrylic resin (from | | 9.2 |
| BASF Performance Chemicals) | | |
| Ethanol | 4.0 | 4.0 |
| Isobutanol | 4.0 | 4.0 |
| Methyl Ethyl Ketone | 15.21 | 23.0 |
| Butyl Acetate | 19.8 | 19.8 |
| S-2022-74 Crosslinker (from Cytec Industries, | 13 | 13 |
| Inc.) | | |
| BYK ™-300 Wetting agent (from Altana) | 0.2 | 0.2 |
| PERENOL ™ E8 Defoamer (from Cognis) | 0.1 | 0.1 |
| Acetone | 7.0 | 7.0 |
| Total | 100 | 100 |

### EXAMPLE 3

In a series of runs, PTSA was added to composition F1 without an anti-blooming additive (coating composition F3) or with varying amounts of the acid-functional polymer JONCRYL 611 as the anti-blooming additive (coating compositions F4 through F7). The coating compositions were coated, crosslinked and evaluated to assess blooming and clarity. The results are shown below in Table 3:

TABLE 3
Coating Bloom and Clarity with Acid-Functional Polymer Addition

| | F3 | F4 | F5 | F6 | F7 |
|---|---|---|---|---|---|
| F1, Parts | 100 | 100 | 100 | 100 | 100 |
| PTSA solution**, | 1.4 | 1.4 | 1.4 | 1.4 | 1.4 |
| parts | | | | | |
| JONCRYL 611 | 0 | 10 | 20 | 30 | 40 |
| solution*, parts | | | | | |
| Bloom/Clarity | 5 | 4 | 3 | 1 | 0 |

*57.3% solids in 50:50 methanol:isopropanol.
**30% solids in 50:50 MEK:butyl acetate.

The results in Table 3 show that severe blooming was observed when an anti-blooming additive was not present. As an anti-blooming additive was added in increasing amounts, blooming and clarity steadily improved and substantially non-blooming coatings were obtained.

### EXAMPLE 4

Using the method of Example 3, composition F2 (which already contained the hydroxyl-functional polymer JONCRYL 587) was combined with PTSA (coating composition F8), or with PTSA and varying amounts of acid-functional polymer (JONCRYL 611) as a further anti-blooming additive (coating compositions F9 through F12). The coating compositions were coated, crosslinked and evaluated to assess blooming and clarity. The results are shown below in Table 4:

TABLE 4
Coating Bloom and Clarity with Further Acid-Functional
Polymer Addition

| | F8 | F9 | F10 | F11 | F12 |
|---|---|---|---|---|---|
| F2, Parts | 100 | 100 | 100 | 100 | 100 |
| PTSA solution, | 1.4 | 1.4 | 1.4 | 1.4 | 1.4 |
| parts | | | | | |
| JONCRYL 611 | 0 | 10 | 20 | 30 | 40 |
| solution, parts | | | | | |
| Bloom/Clarity | 3 | 1 | 0 | 0 | 0 |

The results in Table 4 and comparison to composition F3 in Table 3 show that the presence of an acid-functional polymer anti-blooming additive in coating composition F8 provided a significant improvement in blooming and clarity. The results in Table 4 also show that when increasing amounts of a further acid-functional polymer anti-blooming additive were added, blooming and clarity improved and substantially non-blooming coatings were obtained.

### EXAMPLE 5

Using the method of Example 3, composition F1 was combined with PTSA (coating composition F3), or with PTSA and varying amounts of glycol agent (VORANOL 232-034 triol polyether polymer) as an anti-blooming additive (coating compositions F13 through F16). The coating compositions were coated, crosslinked and evaluated to assess blooming and clarity. The results are shown below in Table 5:

TABLE 5
Coating Bloom and Clarity with Glycol Agent Addition

| | F3 | F13 | F14 | F15 | F16 |
|---|---|---|---|---|---|
| F1, Parts | 100 | 100 | 100 | 100 | 100 |
| PTSA solution, | 1.4 | 1.4 | 1.4 | 1.4 | 1.4 |
| parts | | | | | |
| VORANOL 232- | 0 | 1.5 | 3 | 6 | 10 |
| 034 solution, | | | | | |
| parts | | | | | |
| Bloom/Clarity | 5 | 1 | 0 | 0 | 0 |

The results in Table 5 show that a very small addition of the glycol agent provided a significant improvement in blooming and clarity.

### EXAMPLE 6

Using the method of Example 3, composition F1 was combined with PTSA (coating composition F3), or with PTSA and varying amounts of a further acidic cure catalyst having greater hydrophobicity than PTSA (NACURE 155 dinonylnaphthalene disulfonic acid) as an anti-blooming additive (coating compositions F17 through F21). The coating compositions were coated, crosslinked and evaluated to assess blooming and clarity and MEK rub resistance. The results are shown below in Table 6:

TABLE 6
Coating Bloom and Clarity with Further
Acidic Cure Catalyst Addition

| | F3 | F17 | F18 | F19 | F20 | F21 |
|---|---|---|---|---|---|---|
| F1, Parts | 100 | 100 | 100 | 100 | 100 | 100 |
| PTSA solution, | 1.4 | | 1.26 | 0.98 | 0.70 | 0.42 |
| parts | | | | | | |
| NACURE 155, | | 1.46 | 0.146 | 0.438 | 0.73 | 0.876 |
| parts | | | | | | |
| Bloom/Clarity | 5 | 0 | 3 | 0 | 0 | 0 |
| MEK Double | 29 | 20 | 28 | 28 | 28 | 25 |
| Rubs | | | | | | |

The results in Table 6 show that use of the further acidic cure catalyst provided an improvement in blooming and clarity, but that use of the further acidic cure catalyst without PTSA yielded reduced MEK rub resistance. When PTSA and the further acidic cure catalyst were both employed, substantially non-blooming coatings with MEK rub resistance were obtained using a reduced overall catalyst amount.

### EXAMPLE 7

Using the method of Example 6, composition F2 was combined with PTSA (coating composition F8), or with PTSA and varying amounts of NACURE 155 (coating compositions F22 through F26). The coating compositions were coated, crosslinked and evaluated to assess blooming and clarity and MEK rub resistance. The results are shown below in Table 7:

TABLE 7
Coating Bloom and Clarity with Further
Acidic Cure Catalyst Addition

| | F8 | F22 | F23 | F24 | F25 | F26 |
|---|---|---|---|---|---|---|
| F2, Parts | 100 | 100 | 100 | 100 | 100 | 100 |
| PTSA solution, | 1.4 | | 1.26 | 0.98 | 0.70 | 0.42 |
| parts | | | | | | |
| NACURE 155, | | 1.46 | 0.146 | 0.438 | 0.73 | 0.876 |
| parts | | | | | | |
| Bloom/Clarity | 3 | 0 | 1 | 0 | 0 | 0 |
| MEK Double | 39 | 30 | 38 | 37 | 36 | 36 |
| Rubs | | | | | | |

The results in Table 7 show that use of the further acidic cure catalyst provided an improvement in blooming and clarity, but that use of the further acidic cure catalyst without PTSA yielded reduced MEK rub resistance. When PTSA and the further acidic cure catalyst were both employed, substantially non-blooming coatings with MEK rub resistance were obtained using a reduced overall catalyst amount.

### EXAMPLE 8

Using the method of Example 7, composition F2 was combined with PTSA (coating composition F8), or with PTSA and varying amounts of NACURE 3056 (coating compositions F27 through F31). The coating compositions were coated, crosslinked and evaluated to assess blooming and clarity and MEK rub resistance. The results are shown below in Table 8:

TABLE 8
Coating Bloom and Clarity with Further
Acidic Cure Catalyst Addition

| | F8 | F27 | F28 | F29 | F30 | F31 |
|---|---|---|---|---|---|---|
| F2, Parts | 100 | 100 | 100 | 100 | 100 | 100 |
| PTSA solution, | 1.4 | | 1.26 | 0.98 | 0.70 | 0.42 |
| parts | | | | | | |
| NACURE 155, | | 1.61 | 0.161 | 0.483 | 0.805 | 1.13 |
| parts | | | | | | |
| Bloom/Clarity | 3 | 0 | 1 | 0 | 0 | 0 |
| MEK Double | 39 | 29 | 39 | 38 | 38 | 37 |
| Rubs | | | | | | |

The results in Table 8 show that use of the further acidic cure catalyst provided an improvement in blooming and clarity, but that use of the further acidic cure catalyst without PTSA yielded reduced MEK rub resistance. When PTSA and the further acidic cure catalyst were both employed, substantially non-blooming coatings with MEK rub resistance were obtained.

### COMPARISON EXAMPLE 1

Composition F1 was combined with 0.3, 0.75 and 1.5 wt % boric acid. The boric acid did not appear to dissolve in any of the mixtures. The mixtures had a hazy appearance and did not cure to a tack-free state.

In addition to the disclosed liquid coating composition, coated article and method containing or employing the disclosed crosslinkable film-forming polymer, acidic cure catalyst, low formaldehyde amino resin crosslinker and anti-blooming agent, the disclosed invention also includes liquid coating compositions, coated articles and methods wherein, in any combination or subcombination of the following:
the crosslinkable film forming polymer comprises an alkyd resin;
the alkyd resin is hydroxyl-functional, acid-functional or both hydroxyl- and acid-functional;
the alkyd resin has an acid number of about 2 to about 30;
the alkyd resin has a number average molecular weight between about 2,000 and about 7,000;
the crosslinkable film forming polymer comprises an acrylic, polyester, vinyl or cellulose acetate butyrate resin or a nitrocellulose lacquer;
the acidic cure catalyst comprises a mineral acid, sulfonic acid, aliphatic acid or phosphorus acid;
the anti-blooming agent comprises an acid-functional polymer;
the acid-functional polymer comprises a carboxyl-functional acrylic, carboxyl-functional acrylic polyol or carboxyl-functional alkyd;
the acid-functional polymer has an acid number of about 2 to about 200;
the acid-functional polymer is reactive with the crosslinkable film-forming polymer or amino resin crosslinker;
the anti-blooming agent comprises ethylene glycol, propylene glycol or an ethylene glycol or propylene glycol polymer or copolymer;
the anti-blooming agent has a number average molecular weight of 62 to about 50,000;
the composition comprises p-toluene sulfonic acid and a further acidic cure catalyst having greater hydrophobicity than p-toluene sulfonic acid;
the further acidic cure catalyst comprises dinonylnaphthalene sulfonic acid, dinonylnaphthalene disulfonic acid or dodecyl benzene sulfonic acid;
the liquid coating composition is a homogenous mixture;
the liquid coating composition contains about 5 to about 40 weight percent nonaqueous solvent based on the total composition weight;
the liquid coating composition is waterborne and contains about 10 to about 70 weight percent water based on the total composition weight; or
the liquid coating composition is applied to plastic, metal, masonry or wood (including veneered wood and engineered wood).

Having thus described the preferred embodiments of the present invention, those of skill in the art will readily appreciate that the teachings found herein may be applied to yet other embodiments within the scope of the claims hereto attached. The complete disclosure of all patents, patent documents, and publications are incorporated herein by reference as if individually incorporated.

1. A liquid coating composition comprising sufficient amounts of:
(a) crosslinkable film-forming polymer,
(b) acidic cure catalyst,
(c) low formaldehyde amino resin crosslinker, and
(d) anti-blooming agent comprising one or more of:
(i) acid-functional polymer,
(ii) ethylene glycol, propylene glycol or an ethylene glycol or propylene glycol polymer or copolymer, or
(iii) for compositions containing the acidic catalyst p-toluene sulfonic acid, further acidic cure catalyst having greater hydrophobicity than p-toluene sulfonic acid
to provide a substantially non-blooming crosslinked coating when a continuous film of such composition is applied to a suitable substrate.

2. A composition according to claim 1 wherein the crosslinkable film forming polymer comprises an alkyd resin.

3. A composition according to claim 2 wherein the alkyd resin is hydroxyl-functional, acid-functional or both hydroxyl- and acid-functional.

4. A composition according to claim 2 wherein the alkyd resin has an acid number of about 2 to about 30.

5. A composition according to claim 2 wherein the alkyd resin has a number average molecular weight between about 2,000 and about 7,000.

6. A composition according to claim 1 wherein the crosslinkable film forming polymer comprises an acrylic, polyester, vinyl or cellulose acetate butyrate resin or a nitrocellulose lacquer.

7. A composition according to claim 1 wherein the acidic cure catalyst comprises a mineral acid, sulfonic acid, aliphatic acid or phosphorus acid.

8. A composition according to claim 1 wherein the anti-blooming agent comprises an acid-functional polymer.

9. A composition according to claim 1 wherein the acid-functional polymer comprises a carboxyl-functional acrylic, carboxyl-functional acrylic polyol or carboxyl-functional alkyd.

10. A composition according to claim 1 wherein the acid-functional polymer has an acid number of about 2 to about 200.

11. A composition according to claim 1 wherein the acid-functional polymer is reactive with the crosslinkable film-forming polymer or amino resin crosslinker.

12. A composition according to claim 1 wherein the anti-blooming agent comprises ethylene glycol, propylene glycol or an ethylene glycol or propylene glycol polymer or copolymer.

13. A composition according to claim 12 wherein the anti-blooming agent has a number average molecular weight of 62 to about 50,000.

14. A composition according to claim 1 comprising p-toluene sulfonic acid and a further acidic cure catalyst having greater hydrophobicity than p-toluene sulfonic acid.

15. A composition according to claim 14 wherein the further acidic cure catalyst comprises dinonylnaphthalene sulfonic acid, dinonylnaphthalene disulfonic acid or dodecyl benzene sulfonic acid.

16. A composition according to claim 1 wherein the liquid coating composition is a homogenous mixture.

17. A composition according to claim 1 wherein the liquid coating composition contains about 5 to about 40 weight percent nonaqueous solvent based on the total composition weight.

18. A composition according to claim 1 wherein the liquid coating composition is waterborne and contains about 10 to about 70 weight percent water based on the total composition weight.

19. A coated article comprising a substrate having thereon a layer of a liquid coating composition comprising a homogenous mixture containing sufficient amounts of:
(a) crosslinkable film-forming polymer,
(b) acidic cure catalyst,
(c) low formaldehyde amino resin crosslinker, and
(d) anti-blooming agent comprising one or more of:
(i) acid-functional polymer,
(ii) ethylene glycol, propylene glycol or an ethylene glycol or propylene glycol polymer or copolymer, or
(iii) for compositions containing the acidic catalyst p-toluene sulfonic acid, further acidic cure catalyst having greater hydrophobicity than p-toluene sulfonic acid
to provide a substantially non-blooming crosslinked coating when such layer is crosslinked or otherwise hardened.

20. A method for coating an article, which method comprises applying to a suitable substrate a liquid coating composition comprising a homogeneous mixture of:
(a) crosslinkable film-forming polymer,
(b) acidic cure catalyst,
(c) low formaldehyde amino resin crosslinker, and
(d) anti-blooming agent comprising one or more of:
(i) acid-functional polymer,
(ii) ethylene glycol, propylene glycol or an ethylene glycol or propylene glycol polymer or copolymer, or
(iii) for compositions containing the acidic catalyst p-toluene sulfonic acid, further acidic cure catalyst having greater hydrophobicity than p-toluene sulfonic acid
and crosslinking the coating composition to provide a hardened continuous substantially non-blooming film.
